(19) United States
(12) Patent Application Publication
(10) Pub. No.: US 2021/0201367 A1
(43) Pub. Date: Jul. 1, 2021

(54) METHOD AND SYSTEM FOR DEALING WITH PUBLIC SENTIMENTS, USER TERMINAL AND COMPUTER READABLE STORAGE MEDIUM

(71) Applicant: SUZHOU DEEPLEAPER INFORMATION AND TECHNOLOGY COMPANY LIMITED, Jiangsu (CN)

(72) Inventors: Dongjun Li, Beijing (CN); Ran Wang, Beijing (CN)

(21) Appl. No.: 16/066,656

(22) PCT Filed: Jul. 26, 2017
(86) PCT No.: PCT/CN2017/094534

§ 371 Date: Jun. 27, 2018

(30) Foreign Application Priority Data
Jan. 12, 2017 (CN) 201710023211.0

(51) Int. Cl. G06Q 30/02; G06Q 50/26

(52) U.S. Cl. CPC G06Q 30/0282; G06Q 50/26

(57) ABSTRACT

Provided are a method and a system for dealing with public sentiment, a user terminal and a computer readable storage medium, relating to the technical field of network public relations. An exemplary method includes acquiring browse information of a user; analyzing the browse information to obtain an analysis result; determining, based on the analysis result, whether the browse information needs to be dealt with; selecting, if needing to be dealt with, crisis-dealing information corresponding to the browse information; and displaying the crisis-dealing information. The present disclosure can push a public sentiment crisis-dealing article to users who need to be dealt with, so as to prevent the crisis-dealing article from being viewed by all people, which reduces a negative influence.

### CROSS-REFERENCE TO RELATED APPLICATIONS

This application is a 371 U.S. National Phase of International patent application No. PCT/CN2017/094534, filed Jul. 26, 2017 (attached hereto as Appendix A) and which claims benefit/priority of Chinese Patent Application No. 2017100232110, entitled “Method and System for Dealing with Public Sentiments”, filed Jan. 12, 2017, the entire content of all of which are incorporated herein by reference in entirety.

### TECHNICAL FIELD

The present disclosure relates to the technical field of network public relations, and particularly to a method and a system for dealing with public sentiments, a user terminal and a computer readable storage medium.

### BACKGROUND ART

Nowadays where network is becoming more and more popular, events of dealing with (handling) network public sentiment crisis may occur at any time. Network public sentiment handling is a new thinking manner for modern public relations. Planning ideas and propagation media aims to establish a positive image for the government via high-tech means such as Internet. Network public sentiment crisis handling, belonging to merely one aspect of modern public relations, is handling performed by government organizations on emerged network public sentiment crises and negative influences. Currently, online public relations are mainly solved by publishing news releases, and all people may read the releases for public relations (crisis-dealing articles), which may easily result in a greater negative influence.

### SUMMARY

In view of this, an object of the present disclosure is to provide a method and a system for dealing with public sentiments, a user terminal and a computer readable storage medium, capable of pushing a public sentiment crisis-dealing article for a public sentiment to users who need to be dealt with, thus preventing the crisis-dealing article from being read by all people and reducing a negative influence.

In a first aspect, an embodiment of the present disclosure provides a method for dealing with public sentiments, including steps of: acquiring browse information (reading information) of a user; analyzing the browse information to obtain an analysis result; judging, based on the analysis result, whether the browse information needs to be dealt with; selecting, if needing to be dealt with, crisis-dealing information corresponding to the browse information; and displaying the crisis-dealing information.

In combination with the first aspect, an embodiment of the present disclosure provides a first possible example for the first aspect. Specifically, the step of analyzing the browse information to obtain an analysis result includes steps of: analyzing the browse information to obtain a sentimental polarity of the browse information; and determining, if the sentimental polarity of the browse information is negative, that the browse information needs to be dealt with.

In combination with the first aspect, an embodiment of the present disclosure provides a second possible example for the first aspect. Specifically, the browse information includes historical browse information, and the step of analyzing the browse information to obtain an analysis result includes a step of: performing back-tracing and semantic interpretation on the historical browse information to obtain browse information of the user which is negative information.

In combination with the first aspect, an embodiment of the present disclosure provides a third possible example for the first aspect. Specifically, the browse information includes current browse information, and the step of analyzing the browse information to obtain an analysis result includes the a step of: semantically interpreting the current browse information to obtain an interpreted result, with the interpreted result used as the analysis result.

In combination with the first aspect, an embodiment of the present disclosure provides a fourth possible example for the first aspect. Specifically, a mode for analyzing the browse information includes at least one of the following modes: keyword interpreting, natural language processing, machine learning and entity-tagging technique.

In combination with the first aspect, an embodiment of the present disclosure provides a fifth possible example of the first aspect. Specifically, the step of selecting if needing to be dealt with crisis-dealing information corresponding to the browse information includes the steps of: searching, if needing to be dealt with, to determine whether there is the crisis-dealing information corresponding to the browse information, wherein if there is no crisis-dealing information corresponding to the browse information, the browse information is tagged as information to be dealt with; and if there is crisis-dealing information corresponding to the browse information, the crisis-dealing information is selected.

In combination with the fifth possible example of the first aspect, an embodiment of the present disclosure provides a sixth possible example for the first aspect. Specifically, the method further includes the steps of: acquiring release time of the information to be dealt with as first time; acquiring release time of the crisis-dealing information corresponding to the information to be dealt with, as second time; acquiring the historical browse information of the user between the first time and the second time, and searching to determine whether the historical browse information includes the information to be dealt with; and displaying, if the information to be dealt with is included, the crisis-dealing information corresponding to the information to be dealt with.

In combination with the sixth possible example of the first aspect, an embodiment of the present disclosure provides a seventh possible example for the first aspect. Specifically, the step of displaying if the information to be dealt with is included the crisis-dealing information corresponding to the information to be dealt with includes the steps of: acquiring, by statistics, attention degree paid by the user to the information to be dealt with between the first time and the second time, if the information to be dealt with is included; and displaying, if the attention degree achieves a preset condition, the crisis-dealing information corresponding to the information to be dealt with.

In combination with the first aspect, an embodiment of the present disclosure provides an eighth possible example for the first aspect. Specifically, the attention degree includes at least one of the following information: browse (reading) duration, browse (reading) number and whether a comment is made.

In combination with the first aspect, an embodiment of the present disclosure provides a ninth possible example for the first aspect. Specifically, the step of displaying the crisis-dealing information includes: displaying the crisis-dealing information at a lower portion of a first screen of current browse information.

In combination with the first aspect, an embodiment of the present disclosure provides a tenth possible example of the first aspect. Specifically, the step of displaying the crisis-dealing information includes: displaying the crisis-dealing information on a page of a user terminal; or exhibiting the crisis-dealing information in an information flow of a current reading (browse) channel of the user.

The method for dealing with public sentiments, provided by embodiments of the present disclosure, includes the steps of: acquiring browse information of a user; analyzing the browse information to obtain an analysis result; determining, based on the analysis result, whether the browse information needs to be dealt with; selecting, if needing to be dealt with, crisis-dealing information corresponding to the browse information; and displaying the crisis-dealing information, such that a public sentiment crisis-dealing article is able to be pushed to users who need to be dealt with, thus preventing the crisis-dealing article from being read by all people and reducing a negative influence.

In a second aspect, an embodiment of the present disclosure further provides a system for dealing with public sentiments, including: an acquisition unit configured to acquire browse information of a user; an analysis unit configured to analyze the browse information to obtain an analysis result; a judgment unit configured to judge, based on the analysis result, whether the browse information needs to be dealt with; a selection unit configured to select crisis-dealing information corresponding to the browse information, if the browse information needs to be dealt with; and a display unit configured to display the crisis-dealing information.

In combination with the second aspect, an embodiment of the present disclosure provides a first possible example for the second aspect. Specifically, the analysis unit includes: a sentimental polarity analysis subunit configured to analyze the browse information to obtain a sentimental polarity of the browse information; and a crisis-dealing determination subunit configured to determine that the browse information needs to be dealt with if the sentimental polarity of the browse information is negative.

In combination with the second aspect, an embodiment of the present disclosure provides a second possible example of the second aspect. Specifically, the browse information includes historical browse information, and a mode for analyzing the browse information by the analysis unit to obtain an analysis result includes: performing back-tracing and semantic interpretation on the historical browse information to obtain browse information of the user which is negative information.

In combination with the second aspect, an embodiment of the present disclosure provides a third possible example for the second aspect. Specifically, the browse information includes current browse information, and the mode for the analysis unit analyzing the browse information to obtain an analysis result includes: semantically interpreting the current browse information to obtain an interpreted result.

In combination with the second aspect, an embodiment of the present disclosure provides a fourth possible example for the second aspect. Specifically, the mode for the analysis unit analyzing the browse information includes at least one of the following modes: keyword interpreting, natural language processing, machine learning and entity-tagging technique.

In combination with the second aspect, an embodiment of the present disclosure provides a fifth possible example for the second aspect. Specifically, the mode for the selection unit selecting crisis-dealing information corresponding to the browse information if the browse information needs to be dealt with includes: searching, if needing to be dealt with, to determine whether there is the crisis-dealing information corresponding to the browse information, wherein if there is no crisis-dealing information corresponding to the browse information, the browse information is tagged as information to be dealt with; and if there is crisis-dealing information corresponding to the browse information, the crisis-dealing information is selected.

In combination with the second aspect, an embodiment of the present disclosure provides a sixth possible example for the second aspect. Specifically, the system for dealing with public sentiments further includes: a crisis-dealing unit, configured to acquire release time of the information to be dealt with, as first time; acquire release time of the crisis-dealing information corresponding to the information to be dealt with, as second time; acquire historical browse information of the user between the first time and the second time, and search to determine whether the historical browse information includes the information to be dealt with, and display, if the information to be dealt with is included, the crisis-dealing information corresponding to the information to be dealt with.

In combination with the second aspect, an embodiment of the present disclosure provides a seventh possible example of the second aspect. Specifically, the mode for the crisis-dealing unit displaying the crisis-dealing information corresponding to the information to be dealt with if the historical browse information includes the information to be dealt with includes: acquiring, by statistics, attention degree paid by the user to the information to be dealt with, between the first time and the second time, if the information to be dealt with is included; and displaying, if the attention degree achieves a preset condition, the crisis-dealing information corresponding to the information to be dealt with.

In combination with the second aspect, an embodiment of the present disclosure provides an eighth possible example of the second aspect. Specifically, the attention degree includes at least one of the following information: browse duration, browse number and whether a comment is made.

In combination with the second aspect, an embodiment of the present disclosure provides a ninth possible example of the second aspect. Specifically, the display unit is configured for: displaying the crisis-dealing information at a lower portion of a first screen of current browse information.

In combination with the second aspect, an embodiment of the present disclosure provides a tenth possible example of the second aspect. Specifically, the displaying of the crisis-dealing information includes: displaying the crisis-dealing information on a page of a user terminal; or displaying the crisis-dealing information in an information flow of the current reading channel of the user.

The system for dealing with public sentiments, provided by the present disclosure, includes: an acquisition unit for acquiring browse information of a user; an analysis unit for analyzing the browse information to obtain an analysis result; a judgment unit for judging, based on the analysis result, whether the browse information needs to be dealt with; a selection unit for selecting crisis-dealing information corresponding to the browse information, if the browse information needs to be dealt with; and a display unit for displaying the crisis-displaying information, such that a public sentiment crisis-dealing article can be pushed to users who need to be dealt with, so as to prevent the crisis-dealing article from being read by all people, which reduces a negative influence.

In a third aspect, an embodiment of the present disclosure further provides a user terminal. The user terminal includes a memory, a processor and program codes stored in the memory and capable of running on the processor. The steps of the method for dealing with public sentiments provided in embodiments of the present disclosure are implemented when the processor executes the program codes.

In a fourth aspect, an embodiment of the present disclosure further provides a computer readable storage medium, in which program codes are stored. The steps of the method for dealing with public sentiments provided in embodiments of the present disclosure are implemented when the program codes are executed by the processor.

The method and the system for dealing with public sentiments, the user terminal and the computer readable storage medium, provided in embodiments of the present disclosure, can require the browse information of a user, analyze the browse information, and determine, based on the analysis result, whether the browse information needs to be dealt with. If the browse information needs to be dealt with, crisis-dealing information corresponding to the browse information is selected and displayed. In this way, the crisis-dealing information can be pushed to users who need to be dealt with, so as to prevent the crisis-dealing information from being read by all people and further achieve an effect of reducing a negative influence.

Other features and advantages of the present disclosure will be described in the subsequent description, and a part thereof becomes obvious from the description or would be understood by implementing the present disclosure. The objects and other advantages of the present disclosure will be realized and obtained by a structure specifically indicated in the description, in the claims and in the drawings.

In order to make the above-mentioned objects, features and advantages of the present disclosure more obvious and easy to be understood, preferred embodiments will be specifically illustrated and described in detail below with reference to the attached drawings.

### BRIEF DESCRIPTION OF THE DRAWINGS

In order to more clearly describe the technical solutions of the specific embodiments of the present disclosure or in the prior art, the figures required to be used in the description of the specific embodiments or the prior art will be simply presented below. Obviously, the figures described below show certain embodiments of the present disclosure, and for a person ordinarily skilled in the art, other figures can be obtained according to these figures without using any inventive efforts.

FIG. 1 is a flow chart of a method for dealing with public sentiments provided in Embodiment 1 of the present disclosure;

FIG. 2 is a schematic structural view of a system for dealing with public sentiments provided in Embodiment 2 of the present disclosure;

FIG. 3 is a schematic view of browse information in the method for dealing with public sentiments provided in Embodiment 1 of the present disclosure; and

FIG. 4 is a schematic view of the browse information being dealt with, in the method for dealing with public sentiments provided in Embodiment 1 of the present disclosure.

### REFERENCE SIGNS

10—acquisition unit;
20—analysis unit;
30—judgment unit;
40—selection unit; and
50—display unit.

### DETAILED DESCRIPTION OF THE EMBODIMENTS

In order to make the objects, the technical solutions and the advantages of the embodiments of the present disclosure clearer, the technical solutions of the present disclosure will be clearly and comprehensively described below with reference to the attached drawing. Obviously, the described embodiments are merely some of the embodiments of the present disclosure, but not all the embodiments. Any other embodiments, obtained by a person ordinarily skilled in the art without inventive efforts based on the embodiments in the present disclosure, shall fall within the scope of protection of the present disclosure.

Currently, online crisis dealing is mainly realized by publishing news releases; however, the crisis-dealing article would be viewed by all people, which easily results in a greater negative influence. In view of this, the method and the system for dealing with public sentiments provided in the embodiments of the present disclosure can push a public sentiment crisis-dealing article to users who need to be dealt with, so as to prevent the crisis-dealing article from being viewed by all people, which reduces a negative influence.

In order to facilitate the understanding of the embodiments of the present disclosure, a method and a system for dealing with public sentiments disclosed in the embodiments of the present disclosure are firstly introduced in detail.

The method and the system for dealing with public sentiments provided in the embodiments of the present disclosure may be applied to a user terminal provided with at least one application program which can read information. In the present embodiment, the terminal might be any intelligent terminal that can be used by a user, such as a smartphone, a tablet computer or the like.

The user terminal includes a memory and a processor. The memory and the processor communicate with each other through one or more buses/signal lines. The memory can be configured to store software programs and function modules, e.g. program instructions/modules corresponding to the method and the system for dealing with public sentiments provided in the embodiments of the present disclosure. The processor executes various functional applications and data processing, e.g. the method for dealing with public sentiments provided in the embodiments of the present disclosure, by running the software programs and modules stored in the memory.

### Embodiment 1

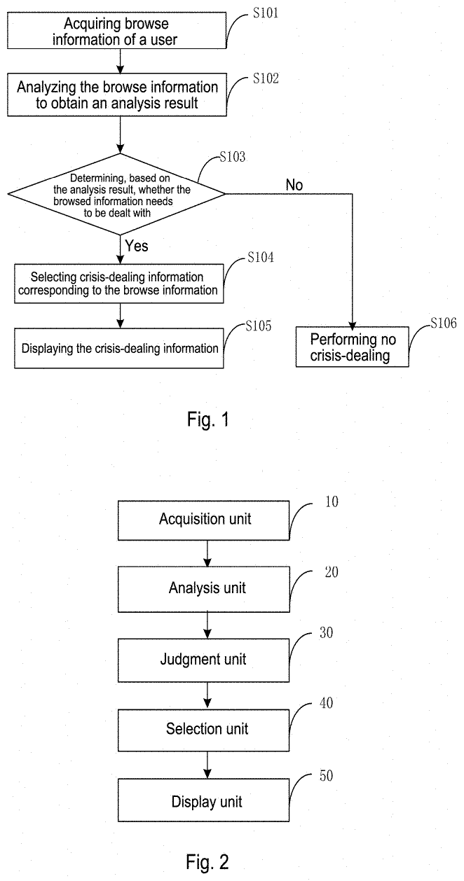

FIG. 1 is a flow chart of a method for dealing with public sentiments provided in Embodiment 1 of the present disclosure.

Referring to FIG. 1, the method for dealing with public sentiments includes:

Step S101: acquiring browse information of a user;

Optionally, the browse information of the user includes current browse information and historical browse information of the user. In the present embodiment, the user can open a website or an APP (Application) via a terminal to read contents of an information flow, click a specific content that the user wants to read, and then enter a detail page to start reading. After reading, a reading log would be generated. The user terminal may acquire historical browse information of the user via the reading log, or may also directly acquire the current browse information of the user.

Step S102: analyzing the browse information to obtain an analysis result;

Optionally, the mode for semantically interpreting the browse information of the user may include at least one of keyword interpreting, natural language processing, machine learning and entity-tagging technique, in this way, specific contents of the browse information can be obtained accordingly.

Optionally, Step S102 can be realized through the steps of: analyzing the browse information to obtain a sentimental polarity of the browse information, and determining that the browse information needs to be dealt with, if the sentimental polarity of the browse information is determined to be negative.

Step S103: judging, based on the analysis result, whether the browse information needs to be dealt with, wherein If the browse information needs to be dealt with, step S104 is executed, and if the browse information does not need to be dealt with, step S106 is executed;

In the present embodiment, whether the browse information needs to be dealt with is judged based on the specific contents of the browse information. For example, if the browse information is a piece of negative information, it may need to be dealt with.

Step S104: selecting crisis-dealing information corresponding to the browse information;

It should be indicated that crisis-dealing information may be in various forms such as picture, text, video and image-text. If the browse information is a piece of negative information needing to be dealt with, searching is performed to determine whether there is a crisis-dealing article matching the browse information, wherein if yes, the crisis-dealing article is selected, and if no, no crisis-dealing article is selected, and this browse information is tagged as information to be dealt with. It should be understood that the information to be dealt with indicates browse information which needs to be dealt with but for which no crisis-dealing information is ready.

Thus, optionally, the step of selecting crisis-dealing information corresponding to the browse information if the browse information needs to be dealt with includes the following sub-steps:

Step S201: searching if the browse information needs to be dealt with, to determine whether there is crisis-dealing information corresponding to the browse information.

Step S202: tagging, if there is no crisis-dealing information corresponding to the browse information, the browse information as information to be dealt with.

Step S203: selecting the crisis-dealing information if there is crisis-dealing information corresponding to the browse information.

Step S105: displaying the PR information.

Step S106: performing no crisis-dealing activity.

In the present embodiment, the crisis-dealing article is exhibited at a corresponding position of a read website or APP, such that users that have read the above-mentioned negative information can read this crisis-dealing article, so as to reduce a negative influence caused by the negative information.

According to an exemplary embodiment of the present disclosure, the browse information may include historical browse information, and the step of analyzing the browse information to obtain an analysis result includes:

performing back-tracing and semantic interpretation on the historical browse information to obtain browse information of the user which is negative information.

According to an exemplary embodiment of the present disclosure, the browse information may include current browse information, and the step of analyzing the browse information to obtain an analysis result includes: semantically interpreting the current browse information to obtain an interpreted result.

Optionally, the current browse information can be semantically interpreted via real-time computing, including at least one of keyword interpreting, natural language processing, machine learning and entity-tagging technique, so that specific contents of the current browse information can be obtained.

Optionally, in a case where there is the information to be dealt with, the method for dealing with public sentiments may further include Step S107, Step S108, Step S109 and Step S110.

Step S107: acquiring release time of the information to be dealt with, as first time.

Step S108: acquiring release time of crisis-dealing information corresponding to the information to be dealt with, as second time.

Step S109: acquiring the historical browse information of the user between the first time and the second time, and searching to determine whether the historical browse information includes the information to be dealt with.

Step S110: displaying, if the information to be dealt with is included, the crisis-dealing information corresponding to the information to be dealt with.

Optionally, step S110 may include the following steps of: acquiring, by statistics, attention degree paid by the user to the information to be dealt with between the first time and the second time, if the information to be dealt with is included; displaying the crisis-dealing information corresponding to the information to be dealt with, when the attention degree reaches a preset condition.

Herein, the attention degree may include at least one of the following information: browse duration and browse number of the user which is the information to be dealt with, and whether a comment is made on the information to be dealt with by the user. The preset condition may be set according to actual circumstances, for example, it is determined that the attention degree reaches the preset condition, if the attention degree paid by the user to the information to be dealt with meets at least one of the following conditions: the browse duration of the user which is the information to be dealt with reaches a preset duration; the browse number of the user which is the information to be dealt with reaches a browse number; and the user has made a comment on the information to be dealt with.

As an example, assuming that the user has read a certain piece of negative information before, however, at that time, the crisis-dealing article for the negative information was not ready yet. Thus, if crisis dealing needs to be performed on the negative information, firstly, the users who have read the negative information need to be acquired, and then the users who pay more attention to the negative information are determined according to comments, browse duration or browse number of a user which is the negative information, so that these users are dealt with by pushing a prepared crisis-dealing article to these users.

Furthermore, assuming that a certain piece of negative information occurred on Feb. 11, 2016, and the crisis-dealing article was not ready until Feb. 13, 2016, the crowd having read the negative information during a duration from the 11th to the 13th before the release of the crisis-dealing article can be obtained based on an analysis, so as to be accurately dealt with, and it can also be analyzed whether a user has read the above-mentioned negative information or not if the user is on a website or an APP, so as to directionally push a crisis-dealing article.

In the embodiment of the present disclosure, the step of displaying the crisis-dealing information can include: displaying the crisis-dealing information at a lower portion of a first screen of current browse information.

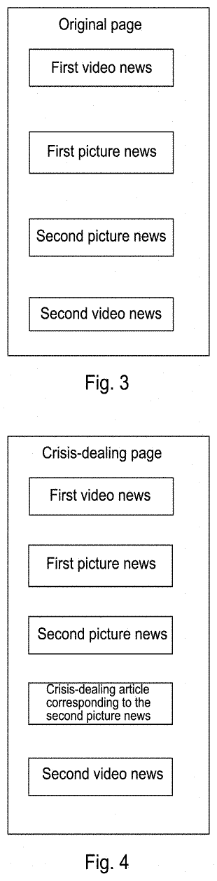

Optionally, FIG. 3 shows an original page currently read by a user, including first video news, first picture news, second picture news and second video news. It is assumed that the content of the second picture news was “Note 7 from Samsung was forced out by multiple countries”, which was a piece of negative news of Samsung, and if the user clicked this article of Samsung, a crisis-dealing article corresponding to the second picture news would be inserted after the news. For example, the content of the crisis-dealing article could be “Samsung starts local phone change plan for Note 7, and consumers can apply for phone change for free”, thus the user can read this crisis-dealing article, after reading the negative news of Samsung (Note 7 from Samsung was forced out by multiple countries) and returning. Reference can be made to FIG. 4 for details.

It should be clarified that the crisis-dealing article may also be placed before or after other contents of the original information flow shown in FIG. 3, as long as the user can see the crisis-dealing article.

According to an exemplary embodiment of the present disclosure, the step of displaying the crisis-dealing information may include: displaying the crisis-dealing information on a page of a user terminal; or exhibiting the crisis-dealing information in an information flow of a current reading channel of the user.

Here, when crisis dealing is performed on the historical browse information of the user, the crisis-dealing article may be exhibited on a home page of the read website or APP entered by the user, or may also be exhibited in the information flow of the current reading channel of the user, or may also be exhibited in a next information flow following the information flow of the reading channel of the user, such that the user can read the crisis-dealing article. The reading channel includes an entertainment channel, a sports channel, a finance channel and the like, and the above-mentioned crisis-dealing article can be exhibited in any channel as long as it can be read by the user. Herein, the next information flow following the current information flow refers to an information flow that can be acquired after a refreshing operation on the basis of the currently read information flow.

It is to be clarified that the above-mentioned method for dealing with public sentiments is applicable to mobile equipment, computer equipment and other types of terminals suitable for exhibiting an information flow.

The present disclosure provides the method for dealing with public sentiments, including the steps of: acquiring browse information of the user; analyzing the browse information to obtain the analysis result; determining, based on the analysis result, whether the browse information needs to be dealt with; selecting, if the browse information needs to be dealt with, crisis-dealing information corresponding to the browse information; and displaying the crisis-dealing information, such that the public sentiment crisis-dealing article can be pushed to users who need to be dealt with, so as to prevent the crisis-dealing article from being viewed by all people, which reduces the negative influence.

### Embodiment 2

FIG. 2 is a schematic structural view of a system for dealing with public sentiments provided in Embodiment 2 of the present disclosure.

Referring to FIG. 2, the system for dealing with public sentiments includes: an acquisition unit 10 configured to acquire browse information of a user;

Specifically, the browse information of the user includes current browse information and historical browse information of the user. Here, the user can open a website or APP (Application) via a terminal to read contents of an information flow, click specific contents that the user wants to read, and then enter the detail page to start the reading. After reading, a reading log would be generated. Thus, the acquisition unit can acquire the browse information of the user.

an analysis unit 20 configured to analyze the browse information to obtain an analysis result; a judgment unit 30 configured to judge, based on the analysis result, whether the browse information needs to be dealt with;

a selection unit 40 configured to select crisis-dealing information corresponding to the browse information in the case that the browse information needs to be dealt with;

It is to be clarified that crisis-dealing information may be in various forms such as picture, text, video and image-text. In a situation where the browse information is a piece of negative information needing to be dealt with, a crisis-dealing article matching the browse information is searched, wherein If it is found, the crisis-dealing article is selected, and if it is not found, the browse information is tagged as information to be dealt with.

Optionally, a mode for the selection unit 40 selecting crisis-dealing information corresponding to the browse information in a situation where the browse information needs to be dealt with includes: searching, if the browse information needs to be dealt with, to determine whether there is crisis-dealing information corresponding to the browse information, wherein if there is no crisis-dealing information corresponding to the browse information, the browse information is tagged as information to be dealt with; and if there is crisis-dealing information corresponding to the browse information, the crisis-dealing information is selected. Optionally, in a case where there is information to be dealt with, the system for dealing with public sentiments can further include a crisis-dealing unit.

The crisis-dealing unit is configured to acquire release time of the information to be dealt with, as first time; acquire release time of the crisis-dealing information corresponding to the information to be dealt with, as second time; acquire historical browse information of the user between the first time and the second time, and searching to determine whether the historical browse information includes the information to be dealt with. If yes, the PR information corresponding to the information to be dealt with is displayed.

Optionally, a mode for the crisis-dealing unit displaying, if the historical browse information includes the information to be dealt with, the crisis-dealing information corresponding to the information to be dealt with includes: acquiring, by statistics, attention degree paid by the user to the information to be dealt with, between the first time and the second time, if the information to be dealt with is included; and displaying the crisis-dealing information corresponding to the information to be dealt with, when the attention degree reaches a preset condition.

Herein, the attention degree may include at least one of the following information: browse duration, browse number and whether a comment is made.

A display unit 50 is configured to display the crisis-dealing information.

In the present embodiment, the crisis-dealing article is exhibited at a corresponding position of the read website or APP, such that users that have read the above-mentioned negative information can read this crisis-dealing article, so as to reduce a negative influence caused by the negative information.

In the embodiment of the present disclosure, the analysis unit 20 can include a sentimental polarity analysis subunit and a crisis-dealing determination subunit.

Herein, the sentimental polarity analysis subunit is configured to analyze the browse information to obtain a sentimental polarity of the browse information.

The crisis-dealing determination subunit is configured to determine, when the sentimental polarity of the browse information is negative, that the browse information needs to be dealt with.

According to an exemplary embodiment of the present disclosure, the browse information includes historical browse information, and a mode for the analysis unit 20 analyzing the browse information to obtain an analysis result may include: performing back-tracing and semantic interpretation on the historical browse information to obtain browse information of the user which is negative information.

According to an exemplary embodiment of the present disclosure, the browse information includes current browse information, and the mode for the analysis unit 20 analyzing the browse information to obtain an analysis result may include: semantically interpreting the current browse information to obtain an interpreted result. In the present embodiment, the mode for the analysis unit 20 analyzing the browse information can include at least one of the following modes: keyword interpreting, natural language processing, machine learning and entity-tagging technique.

According to an exemplary embodiment of the present disclosure, the display unit 50 may be used for: displaying the crisis-dealing information at a lower portion of a first screen of the current browse information.

According to an exemplary embodiment of the present disclosure, the mode for the display unit 50 displaying the crisis-dealing information may include: displaying the crisis-dealing information on a page of a user terminal; or displaying the crisis-dealing information in an information flow of the current reading channel of the user.

In the present embodiment, when performing crisis-dealing on the historical browse information of the user, the crisis-dealing article may be exhibited on a home page of the website or APP to be read by the user, or may also be exhibited in the information flow of the current reading channel of the user, such that the user can read the crisis-dealing article. The reading channel includes an entertainment channel, a sports channel, a finance channel and the like, and the above-mentioned crisis-dealing article can be exhibited in any channel as long as it can be read by the user.

It is to be clarified that the above-mentioned system for dealing with public sentiments is applicable to mobile equipment, computer equipment and other types of terminals suitable for exhibiting an information flow.

The present disclosure provides the system for dealing with public sentiments, including: the acquisition unit 10 configured to acquire the browse information of the user; the analysis unit 20 configured to analyze the browse information to obtain the analysis result; the judgment unit 30 configured to judge, based on the analysis result, whether the browse information needs to be dealt with; the selection unit 40 configured to select crisis-dealing information corresponding to the browse information, if the browse information needs to be dealt with; and the display unit 50 configured to display the crisis-dealing information, such that the public sentiment crisis-dealing article can be pushed to users who needs to be dealt with, so as to prevent the crisis-dealing article to be viewed by all people, which reduces the negative influence.

A computer program product provided in an embodiment of the present disclosure includes a computer readable storage medium in which program codes are stored. An instruction contained in the program codes can be used to execute the method according to the preceding method embodiment. As to specific example, reference can be made to the method embodiment, and no repetitive description will be made here.

It could be clearly understood for a person skilled in the art that for convenience and conciseness of the description, as to the specific working process of the system and the device as mentioned above, reference can be made to the corresponding processes in the preceding method embodiment, and no repetitive description will be made here.

Besides, in the description of the embodiments of the present disclosure, unless otherwise expressly specified and defined, terms such as “mount”, “connect”, and “connection” shall be construed in a broad sense. For example, it may be fixed connection, or detachable connection, or integrated connection; it may be mechanical connection, or electrical connection; or it may be direct connection, or indirect connection via an intermediate, or inner communication between two elements. For a person ordinarily skilled in the art, the specific meanings of the above-mentioned terms in the present disclosure could be construed in accordance with specific circumstances.

If the function is implemented in a form of a software functional unit and is sold or used as an independent product, the function can be stored in one computer readable storage medium. On the basis of such understanding, the technical solution of the present disclosure essentially or a part contributive to the prior art, or a part thereof can be embodied in a form of a software product, and the computer software product is stored in one storage medium, including several instructions to enable computer equipment (which may be a personal computer, a server, or network equipment or the like) to execute all or partial steps of the method described in the respective embodiments of the present disclosure. Moreover, the preceding storage medium includes various media being capable of storing program codes, such as USB flash disk, mobile hard disk, Read-Only Memory (ROM), Random Access Memory (RAM), a disk or a optical disk.

In the description of the present disclosure, it is to be clarified that orientations or position relationships indicated by terms such as “central”, “upper”, “lower”, “left”, “right”, “vertical”, “horizontal”, “inner”, and “outer” are orientations or position relationships based on the drawings, merely for the purpose of facilitating the description of the present disclosure and for simplifying the description, rather than indicating or implying that a specified device or element must have a specific orientation, and be constructed and operated in a certain orientation, and therefore cannot be construed as limiting the present disclosure. In addition, terms such as “first”, “second”, and “third” are used merely for purpose of description, and cannot be construed as indicating or implying to have importance in relativity.

At last, it is to be clarified that the above embodiments are merely specific examples of the present disclosure, and are used to explain the technical solutions of the present disclosure, rather than limiting the same, thus, the scope of protection of the present disclosure is not limited thereto. Although the present disclosure is explained in detail referring to the preceding embodiments, it should be understood for a person ordinarily skilled in the art that any technical person familiar with the present technical field can still readily make modifications or variations to the technical solutions recorded in the preceding embodiments, or substitute a part of the technical features with equivalent, within the technical scope disclosed in the present disclosure. However, these modifications, variations or substitutions do not make the essence of the respective technical solutions depart from the spirit and scope of the technical solutions of the embodiments of the present disclosure, and shall all be covered by the scope of protection of the present disclosure. Thus, the scope of protection of the present disclosure shall be defined according to the scope claimed by the claims.

### INDUSTRIAL APPLICABILITY

The method and the system for dealing with public sentiments, the user terminal and the computer readable storage medium, provided in the embodiments of the present disclosure, acquire the browse information of a user, analyze the browse information, and judge, based on the analysis result, whether the browse information needs to be dealt with, wherein If the browse information needs to be dealt with, crisis-dealing information corresponding to the browse information is selected for displaying. In this way, the crisis-dealing information can be pushed to users who need to be dealt with, so as to prevent the crisis-dealing information from being viewed by all people, which achieves the effect of reducing a negative influence.

1. A method for dealing with public sentiments, comprising steps of:
acquiring browse information of a user;
analyzing the browse information to obtain an analysis result;
judging, based on the analysis result, whether the browse information needs to be dealt with;
selecting, if needing to be dealt with, crisis-dealing information corresponding to the browse information; and
displaying the crisis-dealing information.

2. The method for dealing with public sentiments according to claim 1, wherein the step of analyzing the browse information to obtain an analysis result comprises steps of:
analyzing the browse information to obtain a sentimental polarity of the browse information; and
determining, if the sentimental polarity of the browse information is negative, that the browse information needs to be dealt with.

3. The method for dealing with public sentiments according to claim 1, wherein the browse information comprises historical browse information, and the step of analyzing the browse information to obtain an analysis result comprises a step of:
performing back-tracing and semantic interpretation on the historical browse information to obtain browse information of the user which is negative information.

4. The method for dealing with public sentiments according to claim 1, wherein the browse information comprises current browse information, and the step of analyzing the browse information to obtain an analysis result comprises a steps of:
semantically interpreting the current browse information to obtain an interpreted result, with the interpreted result used as the analysis result.

5. The method for dealing with public sentiments according to claim 1, wherein a mode for analyzing the browse information comprise at least one of following modes:
keyword interpreting, natural language processing, machine learning and entity-tagging technique.

6. The method for dealing with public sentiments according to claim 1, wherein the step of selecting if needing to be dealt with crisis-dealing information corresponding to the browse information comprises step of:
searching, if needing to be dealt with, to determine whether there is the crisis-dealing information corresponding to the browse information,
wherein if there is no crisis-dealing information corresponding to the browse information, the browse information is tagged as information to be dealt with; and
if there is crisis-dealing information corresponding to the browse information, the crisis-dealing information is selected.

7. The method for dealing with public sentiments according to claim 6, wherein the method further comprises steps of:
acquiring release time of the information to be dealt with, as first time;
acquiring release time of the crisis-dealing information corresponding to the information to be dealt with, as second time;
acquiring historical browse information of the user between the first time and the second time, and searching to determine whether the historical browse information comprises the information to be dealt with; and
displaying, if the information to be dealt with is comprised, the crisis-dealing information corresponding to the information to be dealt with.

8. The method for dealing with public sentiments according to claim 7, wherein the step of displaying if the information to be dealt with is comprised the crisis-dealing information corresponding to the information to be dealt with comprises steps of:
acquiring, by statistics, attention degree paid by the user to the information to be dealt with between the first time and the second time, if the information to be dealt with is comprised; and
displaying, when the attention degree reaches a preset condition, the crisis-dealing information corresponding to the information to be dealt with.

9. The method for dealing with public sentiments according to claim 8, wherein the attention degree comprises at least one of following information: browse duration, browse number and whether a comment is made.

10. The method for dealing with public sentiments according to claim 1, wherein the step of displaying the crisis-dealing information comprises:
displaying the crisis-dealing information at a lower portion of a first screen of current browse information; or
displaying the crisis-dealing information on a page of a user terminal; or
exhibiting the crisis-dealing information in an information flow of a current reading channel of the user.

11. (canceled)

12. A system for dealing with public sentiments, comprising:
an acquisition unit configured to acquire browse information of a user;
an analysis unit configured to analyze the browse information to obtain an analysis result;
a judgment unit configured to judge, based on the analysis result, whether the browse information needs to be dealt with;
a selection unit configured to select, if the browse information needs to be dealt with, crisis-dealing information corresponding to the browse information; and
a display unit configured to display the crisis-dealing information.

13. The system for dealing with public sentiments according to claim 12, wherein the analysis unit comprises:
a sentimental polarity analysis subunit configured to analyze the browse information to obtain a sentimental polarity of the browse information; and
a crisis-dealing determination subunit configured to determine, when the sentimental polarity of the browse information is negative, that the browse information needs to be dealt with.

14. The system for dealing with public sentiments according to claim 12, wherein the browse information comprises historical browse information, and a mode for the analysis unit analyzing the browse information to obtain an analysis result comprises:
performing back-tracing and semantic interpretation on the historical browse information to obtain browse information of the user which is negative information.

15. The system for dealing with public sentiments according to claim 12, wherein the browse information comprises current browse information, and a mode for the analysis unit analyzing the browse information to obtain an analysis result comprises:
semantically interpreting the current browse information to obtain an interpreted result, with the interpreted result used as the analysis result.

16. The system for dealing with public sentiments according to claim 12, wherein a mode for the analysis unit analyzing the browse information comprise at least one of following modes:
keyword interpreting, natural language processing, machine learning and entity-tagging technique.

17. The system for dealing with public sentiments according to claim 12, wherein a mode for the selection unit selecting crisis-dealing information corresponding to the browse information if the browse information needs to be dealt with comprises:
searching, if the browse information needs to be dealt with, to determine whether there is crisis-dealing information corresponding to the browse information,
wherein if there is no crisis-dealing information corresponding to the browse information, the browse information is tagged as information to be dealt with; and
if there is crisis-dealing information corresponding to the browse information, the crisis-dealing information is selected.

18. The system for dealing with public sentiments according to claim 17, wherein the system for dealing with public sentiments further comprises:
a crisis-dealing unit, configured to acquire release time of the information to be dealt with, as first time; acquire release time of the crisis-dealing information corresponding to the information to be dealt with, as second time; acquire historical browse information of the user between the first time and the second time, and searching to determine whether the historical browse information comprises the information to be dealt with; and display, if the information to be dealt with is comprised, the crisis-dealing information corresponding to the information to be dealt with.

19. The system for dealing with public sentiments according to claim 18, wherein a mode for the crisis-dealing unit displaying the crisis-dealing information corresponding to the information to be dealt with if the historical browse information comprises the information to be dealt with comprises:
acquiring, by statistics, attention degree paid by the user to the information to be dealt with between the first time and the second time, if the information to be dealt with is comprised; and
displaying, when the attention degree reaches a preset condition, the crisis-dealing information corresponding to the information to be dealt with.

20. The system for dealing with public sentiments according to claim 19, wherein the attention degree comprises at least one of following information: browse duration, browse number and whether a comment is made.

21. The system for dealing with public sentiments according to claim 12, wherein a mode for the display unit displaying the crisis-dealing information comprises:
displaying the crisis-dealing information at a lower portion of a first screen of current browse information; or
displaying the crisis-dealing information on a page of a user terminal; or
displaying the crisis-dealing information in an information flow of the current reading channel of the user.

22.-24. (canceled)
